(19) United States
(12) Patent Application Publication
(10) Pub. No.: US 2020/0062191 A1
(43) Pub. Date: Feb. 27, 2020

(54) Device holder systems for motor vehicles

(71) Applicants: GARY DEAN RAGNER, GAINESVILLE, FL (US); Andrew T. Hayes, Uniontown, FL (US)

(72) Inventors: GARY DEAN RAGNER, GAINESVILLE, FL (US); Andrew T. Hayes, Uniontown, FL (US)

(73) Assignee: RAGNER TECHNOLOGY CORPORATION, GAINESVILLE, FL (US)

(21) Appl. No.: 16/553,132

(22) Filed: Aug. 27, 2019

Related U.S. Application Data
(60) Provisional application No. 62/723,122, filed on Aug. 27, 2018.
(60) Provisional application No. 62/743,523, filed on Oct. 9, 2018.

(51) Int. Cl. B60R 11/02; H04B 1/3888

(52) U.S. Cl. CPC B60R 11/02; B60R 2011/0005; H04B 1/3888

(57) ABSTRACT

A portable device holder 20 for use in a motor vehicle and mounted in a gap between a steering column and a lower dashboard of the motor vehicle and can comprise a removable attachment means 21 with an attachment panel 24, a pivotal hinge 22 and a portable device support means 25. The portable device support means 25 can comprise a magnetic connector 27 for providing a removable mounting means for a smartphone or other portable device. The pivotal hinge 22 can pivotally connect the removable attachment means 21 and the portable device support means 25 so that the portable device support means 25 can pivot to a stowed position and an operational position.

### BACKGROUND

Smart phones have increased in usage during the past decade so that a large percentage of people now use their phones for navigation and other functions while driving. Because of the distraction of using these phones in a motor vehicle (i.e., an automobile), many states have required users to provide a mounting means for their phone for use as a navigation tool. The disclosed phone holders or portable device holders take advantage of a gap between the user's motor vehicle dashboard and steering column to provide a non-adhesive means of holding a smart phone securely in front of a motor vehicle's instrument panel where the user can easily view it. Further, a pivotal hinge can be provided to allow the mounting means and smart phone to pivot down and out of the way to allow unobstructed viewing of the motor vehicle's instrument panel.

### SUMMARY

Nearly all automobiles and motor vehicles now have an adjustable steering wheel which necessitates a gap between the vehicle's steering column and its dashboard to allow for this adjustability. The adjustable steering wheel allows the user to select their preference for the position of the steering wheel. The gap between the motor vehicle's steering column and dashboard can include additional decorative and functional structures that are often constructed of plastic, metal and/or wood. The gap can comprise a vertical channel that extends vertically downward a short distance and then turns about ninety degrees to form a horizontal channel extending toward the front of the motor vehicle (i.e., under the dashboard). The vertical channel can be formed by forward facing decorative components around the steering column and a front surface of the dashboard. The horizontal channel can be formed by a top surface of the steering column and/or decorative components on top of the steering column and an underside surface of the dashboard. The gap can further comprise various other horizontal and vertical surfaces that provide a solid and reliable mounting surface for holding the herein mentioned mobile or portable device holders in place during use. The disclosed portable device holders can use the herein mentioned gap between the steering column (and components attached to the steering column) and the dashboard with its various components and surface. In some embodiments, the horizontal channel portion of the gap can be used to lock a particular portable device holder in place by adjusting the position of the steering wheel (See FIGS. 1 through 3B) and steering column. In other embodiments the vertical channel portion of the gap can used to receive a securing flange or weighted bag (see FIGS. 4B through 5B) to secure the disclosed portable device holders in place. The securing flange or weighted bag can engage the vertical channel to help hold the disclosed portable device holder in place using friction and gravity. In alternative embodiments the disclosed portable device holders can be held in place with adhesives and/or other attachment means. In other embodiments both the horizontal and vertical channel portions of the gap can be used to secure the disclosed portable device holder in place (See FIG. 5C). For example, a particular portable device holder might comprise a securing flange filled with lead shot, or other heavy material. The securing flange can engage both surfaces of the vertical channel to non-adhesively secure the portable device holder in place during use. The securing flange may also extend to the bottom of the vertical channel and rest on the steering column's horizontal channel surface to enhance stability of the portable device holder or may further extend into the horizontal channel to provide even more stable operation.

The presently disclosed portable device holders are designed for use in automobiles and other motor vehicles, and can comprise a removable attachment means for temporarily attaching the portable device holder to a motor vehicle's steering column, dashboard and/or the gap between the steering column and dashboard. The portable device holders can also comprise a portable device support means for temporarily supporting or holding a portable device (e.g., smartphone, cellular phone, computer tablet, kindle, etc.) to the portable device holder during use. The portable device support means can include a magnetic connector for providing a removable mounting means for a portable device or other portable electronic device. The magnetic connector can comprise one or more magnets arranged for gripping metal objects, such as thin metal plates (see metal plates 19a-b in FIG. 2A and 3A). These thin metal plates can be mounted to the back of a portable device and/or an attached protective case or cover. Alternatively, other magnetic means can be used which are not limited to these thin metal plates. For example, the housing of the portable device or tablet can be made of magnetic material that allows mounting to the magnet.

The portable device holder can comprise a pivotal hinge that pivotally connects the removable attachment means and the portable device support means so that they can pivot with respect to one another. The removable attachment means and/or a portion of the removable attachment means can be shaped and otherwise constructed for placement between a motor vehicle's dashboard and its steering column. Most motor vehicles have adjustable steering columns which can be moved to give access to the gap between the steering column and the underside of the dashboard. After the removable attachment means is inserted between the dashboard and steering column, the adjustable steering column can be moved back up until the removable attachment means is securely held between the two surfaces. Various foam padding or similar compliant structures can be bonded to the top and/or bottom surfaces of the removable attachment means, as needed, to provide the desired spacing and positioning of the portable device holder in relationship to the steering column and/or dashboard. In alternate embodiments, the removable attachment means can have a compliant structure built into the removable attachment means to provide an outward expanding force against the top of the motor vehicle's steering column and the underside of the motor vehicle's dashboard. In other embodiments, the removable attachment means can be replaced with two or more spring loaded panels (see FIG. 3B) or other spring loaded structures that can press outward against the underside of the dashboard and the top of the steering column to secure the portable device holder in place during use.

In some embodiments, the disclosed portable device holder can be secured to the steering column and dashboard by using gravity and a properly placed weighted structure to hold the portable device holder in place. In some embodiments, the removable attachment means can comprise a base plate and a conforming structure (e.g., soft clay-like material, conformable weighted bag, a bean bag, sand bags, a hanging weight, lead shot bags and/or other weighted conforming structures) to engage the gap between the steering column and dashboard and provide a stable support for the portable device holder. Similarly, these weighted structures can be designed to extend deep into the gap between the motor vehicle's steering column and dashboard by conforming against the walls of the gap. Note that even a small protrusion of the conforming structure into the gap can significantly improve the stability of the portable device holder when mounted on the motor vehicle's steering column and dashboard. Besides being stabilized by the gap, the disclosed portable device holders can also be stabilized by the removable attachment means resting on, and conforming to, portions of an upper surface of the motor vehicle's steering column and/or an upper surface of the dashboard.

The presently disclosed portable device holders may also comprise various auxiliary components commonly used in combination with a smartphone, a cellular phone, an electronic tablet or other portable electronic device, such as, but not limited to, USB ports (Universal Serial Bus ports), phone charging ports, non-contact charging ports (see FIG. 3A), audio connections, height adjustment structures, front-to-back and/or side-to-side positioning systems, etc. In many embodiments, the portable device holders may be specifically designed to hold a portable device in a portrait orientation (long sides vertical). In the presently disclosed illustrations the various device holders can allow a smart phone and other devices to be removably mounted in either the vertical or horizontal direction (FIGS. 2A through 3A and 5A-B showing the smart phone mounted horizontally on the portable device holders to save space on the drawing sheets). Also, in some embodiments, the disclosed portable device holders can be narrower or wider than shown in FIGS. 1 through 5C.

FIGS. 2A through 3A illustrate three different examples of portable device support means (device support) which are designed to secure a smartphone, a cellular phone, an electronic tablet, a marker board or other small portable device to their respective device holder for use in a motor vehicle. FIG. 2A illustrates a simple magnet that can be used on the support means for securing a portable device. FIG. 2B illustrates a two arm spring loaded system for securing a portable device and FIG. 3A illustrates a dual magnetic securing means with a wireless charger to provide an example of how other functions can be incorporated into the basic portable device holder systems.

FIGS. 2B through 3B illustrate three examples of removable attachment means which are designed to secure the portable device holder to the gap between the motor vehicle's steering column and dashboard. FIG. 2B illustrates a basic attachment means comprising a simple attachment panel designed to be wedged in the gap between the steering column and dashboard of a motor vehicle. FIG. 3A illustrates a removable attachment means similar to the removable attachment means shown in FIG. 2B, but has a longer angled section to extend the position of its pivotal hinge further from this gap between the steering column and dashboard. FIG. 3B illustrates one example of how a spring-loaded system can be used to removably attach a portable device holder to the gap between the steering column and dashboard of a motor vehicle.

FIGS. 4B and 4C illustrate two examples of removable attachment means which are designed to secure the portable device holder to the combination of the motor vehicle's steering column, dashboard and the gap between the steering column and dashboard. FIG. 4B illustrates a basic attachment means comprising an attachment base plate designed to rest on the steering column assembly and dashboard surface with a hanging weight that is dropped in the vertical channel formed by the upper section of the gap between the steering column and dashboard. The placement of the hanging weight helps to resist shifting of the portable device holder either forward or backward and to also lower the center of gravity of the portable device holder. FIG. 4C illustrates a similar attachment means comprising a base plate designed to rest on the steering column assembly and dashboard surface with a weighted bag that can be inserted and shaped in the gap between steering column and dashboard. This positioning of the weighted bag helps hold the base plate in place during use. The placement of the weighted bag in the gap also lowers the center of gravity of the portable device holder which further stabilizes the system. The weighted bag in this case can comprise an elongated bag containing sand, lead shot or other granular material that can allow the elongated bag to conform to the gap above the steering column to securely hold the base plate and portable device holder in place during use.

FIGS. 5A through 5C illustrate two more examples of removable attachment means which are designed to secure the portable device holder to the combination of the motor vehicle's steering column, dashboard and/or the gap between the steering column and dashboard. FIG. 5A-C illustrates a conformable attachment means comprising a base plate with a weighted bag attached to its underside. In some embodiments, the weighted bag can extend to cover the majority of the underside of the base plate. The weighted bag can be designed to conform to the top of the steering column assembly, dashboard surfaces and/or the gap between them. This ability to conform to the uneven surface of the steering column, gap and dashboard can strongly resist the shifting of the removable attachment means forward, backward and side to side. The weight of the granular material within the weighted bag helps lower the center of gravity of the portable device holder which further stabilizes the portable device holder.

FIG. 5C illustrates a similar attachment means comprising a removable attachment with a somewhat cylindrical weighted bag attached to its underside and designed to be at least partially pushed down into the gap between the steering column and dashboard. In some embodiments, the cylindrical weighted bag can conform to the angled portion of the gap and extend into the horizontal channel portion of the gap. The angled nature of the gap near the transition between the vertical and horizontal channels tends to wedge the cylindrical weighted bag in place which can strongly resist movement of the portable device holder in all directions.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a perspective illustration of a first example portable device holder installed between an automotive steering column and its dashboard.

FIG. 2A is a perspective illustration of the first example portable device holder shown in its operational position with a prior art phone magnetically attached for use.

FIG. 2B is a perspective illustration of a second example portable device holder with a phone held in place by spring-loaded arms.

FIG. 3A is a perspective illustration of a third example portable device holder with wireless phone charging coil.

FIG. 3B is a perspective illustration of a fourth example portable device holder with spring loaded attachment panels for gripping the gap between a motor vehicle's steering column and its dashboard.

FIG. 4A is a cross-sectional illustration of the gap between a motor vehicle's steering column and dashboard.

FIG. 4B is a perspective illustration of a fifth example portable device holder with a hanging weight to help secure the holder.

FIG. 4C is a perspective illustration of a sixth example portable device holder with an elongated hanging weighted bag to secure the holder.

FIG. 5A is a perspective illustration of a seventh example portable device holder in its operational position with a conformable weighted bag.

FIG. 5B is a perspective illustration of the seventh example portable device holder seen in FIG. 5A in a stowed position.

FIG. 5C is a perspective illustration of an eighth example portable device holder with an elongated conformable weighted bag.

### DETAILED DESCRIPTION

The present disclosure is related to holders for portable electronic devices and, more particularly, to a portable device holder for use in automobiles, trucks, and other motor vehicles while the user is driving.

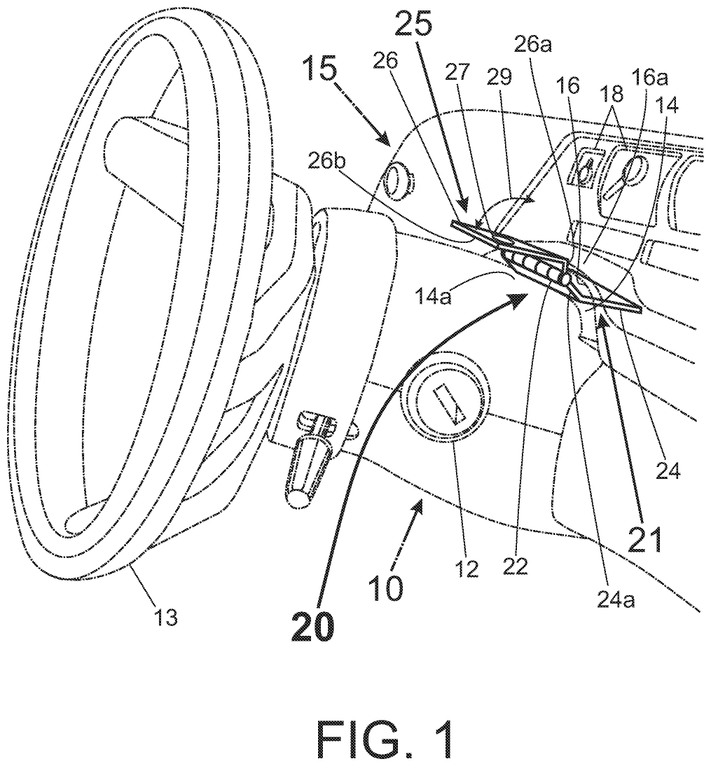

FIG. 1 is a perspective illustration of a first example portable device holder 20, mounted in a prior art motor vehicle between a steering column 10 and a dashboard 15. The steering column 10 generally has a decorative plastic outer covering around the actual metal steering column on most present day vehicles. For the purposes of this invention, this decorative plastic outer covering around the actual steering column can be considered the motor vehicle's steering column (e.g., steering column 10) and can be used to secure the portable device holder 20 to the motor vehicle. According to one or more embodiments of the present disclosure, a motor vehicle can comprise the steering column 10 can comprise an ignition lock 12, a steering wheel 13, an interior mounting surface 14 (hereafter “mounting surface 14”), an upper steering column surface 14a (hereafter “steering column surface 14a”) and the dashboard 15. According to one or more embodiments of the present disclosure the dashboard 15 can comprise an interior mounting surface 16 (hereafter “mounting surface 16”), a lower dashboard surface 16a (hereafter “dashboard surface 16a”) and a motor vehicle instrument panel 18. The mounting surface 14 can be a portion of the steering column 10 that is overhung by the dashboard 15 and mounting surface 16 can be the underside of the dashboard 15. Thus, the mounting surfaces 14 and 16 face each other and are in close proximity to each other to form a gap between them. In most automobiles and motor vehicles, the mounting surfaces 14 and 16 are made from reasonably strong materials, such that, they can support attachment of auxiliary systems such as the disclosed portable device holder 20 and any attached smartphone, cellular phone, electronic tablet or other portable electronic device.

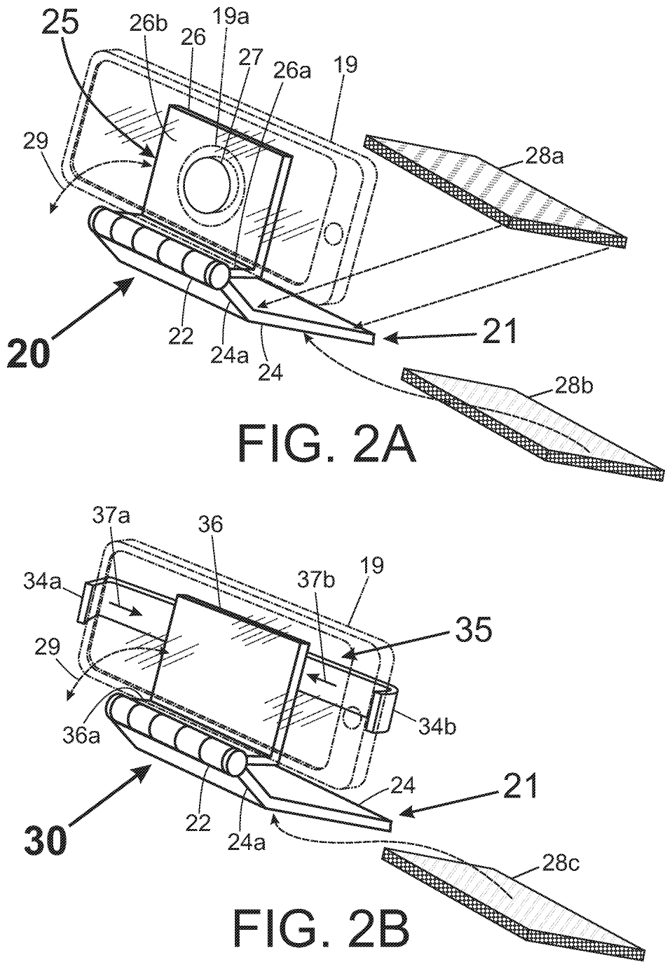

As illustrated, the portable device holder 20 works in combination with the steering column 10 and the dashboard 15. The portable device holder 20 can comprise a removable attachment means 21, a pivotal hinge 22 and a portable device support means 25 (hereafter “device support 25”). The removable attachment means 21 (hereafter “attachment means 21”) can comprise an attachment panel 24 with an angled section 24a and can be designed to be removably mounted in the gap between the mounting surfaces 14 and 16. For most motor vehicles, the angled section 24a can be attached at between ninety and one hundred sixty degrees to the attachment panel 24, with angles of about one hundred twenty degrees working well in most vehicles. The attachment means 21 can be formed into various shapes to fit between the mounting surfaces 14 and 16 and can be made from a number of reasonably strong material(s) (e.g., polymers, composites, metal alloys, etc.) with strengths capable of supporting a prior art portable electronic device. The pivotal hinge 22 can comprise any of a number of prior art hinges that can pivot through at least a ninety degree angle and can include, but are not limited to, spring loading, motion control (i.e., resistance to repositioning), fluid motion control, friction hinges and other hinge types and styles. The device support 25 can comprise a support plate 26 with an angled section 26a, a device mounting surface 26b and a magnetic connector 27. In the illustrated embodiment, the portable device holder 20 can comprise one or more attachable foam pads (see foam pads 28a-b in FIG. 2A) which can be affixed as needed, in various numbers, to adjust for spacing needs of the gap formed between the steering column's mounting surface 14 and the dashboard's mounting surface 16. In FIG. 2A, one or more attachable resilient foam pads 28a-b (hereafter “foam pads 28a-b”) can comprise one or more adhesive coated surfaces that can bond the foam pads 28a-b to the top and/or bottom of the attachment panel 24. In some embodiments, the foam pads 28a-b can be foam pads without adhesives or glues and simply rest against the attachment panel 24, and mounting surfaces 14 and/or 16 to fill in the gap between the mounting surfaces 14 and 16 and hold the attachment panel 24 in place during use. In other embodiments, one or more alternate foam pads, similar to foam pads 28a-b, but in different thicknesses can be stacked by including one or more adhesive surfaces for bonding to the attachment panel 24, foam pads 28a-b and/or the one or more alternate foam pads. These alternate foam pads can be similar to the foam pads 28a-b and may come in several different thicknesses. In this way, and others, the user can adjust the effective thickness of the attachment panel 24 with one or more foam pads similar to the foam pads 28a-b.

In some embodiments, the attachment means 21 can include additional hardware used to help attach the portable device holder 20 to either the mounting surface 14 and/or 16 by a number of well known attachment means, which can comprise, but are not limited to, an adhesive, a glue, a compression fit structure(s), a spring-loaded surface(s), etc.). Ideally, the portable device holder 20 can be removed from the mounting surfaces 14 and 16 without leaving a mark or residue on these structures. Further, in the embodiments shown herein, no tools or chemicals are needed to remove the portable device holder 20 from the gap between the mounting surfaces 14 and 16. Prior art device holders often require solvents to remove from automobile surfaces. Instead, in the illustrated embodiments, one or more foam pads 28a-b (see FIG. 2A) can be used to create a resilient padded structure around the attachment panel 24 that can be compressed between the mounting surfaces 14 and 16 to hold the portable device holder 20 in place without glues or adhesives coming in contact with the steering column 10 or dashboard 15. The gap between the mounting surfaces 14 and 16 combined with the ubiquitous use of adjustable steering columns in modern automobiles, trucks and other motor vehicles, allows this gap to be widened for inserting the attachment panel 24 (and any attached foam pads 28a-b) and then narrowed to grip the attachment panel 24 and any attached foam pads (e.g., foam pads 28a and 28b). In alternate embodiments, a double-sided adhesive resilient foam pad 28c (see FIG. 2B) can be used to bond the attachment panel 24 to the mounting surface 14 on the top surface of the steering column 10 and/or to the mounting surface 16 on the underside of the dashboard 15. In some embodiments, the double-sided adhesive resilient foam pad 28c (hereafter “foam pad 28c”) can be bonded to the underside of attachment panel 24 and then use its second adhesive side to attach the portable device holder 20 to the steering column surface 14a or dashboard surface 16a (i.e., the gap between the steering column 10 and dashboard 15 is not used to secure attachment panel 24 to the motor vehicle). In other embodiments, the foam pads 28a-c can be replaced with one or more inflatable bladders mounted on the attachment panel 24 and be inflatable by the user to wedge the attachment panel 24 securely between the mounting surfaces 14 and 16.

FIG. 2A is a perspective illustration of the example portable device holder 20, seen in FIG. 1, in its operational position with a prior art cellular phone 19 secured to the device mounting surface 26b by the magnetic connector 27. The prior art cellular phone 19 illustrates one example for a portable device that can be attached to the device mounting surface 26b with the magnetic connector 27. Many other portable devices can be used with the portable device holder 20 instead of the prior art cellular phone 19, including but not limited to, a smartphone, an electronic tablet, a GPS map system, a marker board and other useful portable devices. The magnetic connector 27 can comprise one or more magnets which can be spaced across the support plate 26 as needed for specific uses. The magnetic strength of the magnetic connector 27 can be selected for a specific application by selecting the magnetic strength, physical size and/or number of magnets that comprise it. For example, to securely attach a large electronic tablet, the support plate 26 might comprise multiple magnets similar to magnetic connector 27 with alternating polarity to increase its magnetic holding force. A metal plate 19a can be bonded to the back surface of the prior art cellular phone 19 (hereafter “portable device 19”) such that the magnetic connector 27 can hold the portable device 19 in place by attracting the metal plate 19a to itself The metal plate 19a is designed to be strongly attracted to a magnet such as the magnetic connector 27 and can be attached directly to the back surface of the portable device 19 and/or any additional protective cover or case (not shown). In alternate embodiments, the metal plate 19a may not need adhesive to be held in place when placed between the back portion of the portable device 19 and a protective cover or case (not shown), with the magnetic forces passing through the protective cover or case to allow the portable device 19 to be removably attached to the magnetic connector 27 mounted on the device support 25. The magnetic connector 27 can be mounted flush with the device mounting surface 26b so that the portable device 19 has a flat surface to attach to. In other embodiments, the metal plate 19a can comprise an adhesive coated surface that can bond to the surface of the portable device 19 or an attached protective cover or case (not shown). In some embodiments, the metal plate 19a can be a metal plate built directly into the back of the portable device 19.

As illustrated in FIGS. 1 and 2A, the pivotal hinge 22 can allow the device support 25 to pivot in relationship to the attachment panel 24 and allow the device support 25 to pivot over the pivotal range 29 between a substantially lowered or stowed position, as seen in FIG. 1, and a substantially raised or operational position for viewing the display of a smartphone or other electronic device for the user to view and access, as seen in FIG. 2A. The magnetic connector 27 can comprise one or more strong magnet(s) that is(are) designed to attract the metal plate 19a, such that, the portable device 19, an electronic tablet or other portable device can be mounted to the device mounting surface 26b and provide a secure, but removable, attachment to the device support 25 (see FIG. 2A). In some embodiments, the device mounting surface 26b can have a rubberized cover on it to help the portable device 19 and other portable devices from being scratched when magnetically attached to the device mounting surface 26b. The angled section 26a can act as a guide and/or lower support for the portable device 19 or other portable electronic device and also offsets the position of the portable device 19 or other electronic device so that in a stowed position, with the support plate 26 positioned as shown in FIG. 1, the portable device or other electronic device can rest substantially face down against the upper surface of the steering column 10 (i.e., steering column surface 14a).

As illustrated in FIG. 2A, one or more foam pads 28a and 28b can be mounted to the top and/or bottom surface of the attachment panel 24 respectively. This can increase the attachment plate's apparent thickness and allow it to press against surfaces like the mounting surfaces 14 and 16 seen in FIG. 1 to secure the portable device holder 20 to a gap between a particular motor vehicle steering column and dashboard. The angled section 24a at one end of the attachment panel 24 can be used to raise the position of the pivotal hinge 22 above any obstructions that might exist on a particular motor vehicle's steering column. Many motor vehicles have the steering column's mounting surface 14 slightly indented right at the mounting surface 16 of the dashboard 15 for cosmetic reasons. Thus, the angled section 24a can raise the pivotal hinge 22 sufficiently above the upper surface of the steering column 10 (i.e., steering column surface 14a), that when the device support 25 is pivoted to its stowed position (see FIG. 1), the attached portable device 19 can pivot to lay relatively flat against the steering column surface 14a and not bind against the steering column 10. This stowed position, for the device support 25 and attached portable device 19, can allow a user a substantially unobstructed view of an instrument panel on the automobile (i.e., a motor vehicle). The angled section 24a also can position the pivotal hinge 22 slightly forward of the front face of the motor vehicle instrument panel 18 (hereafter “instrument panel 18”) so that the device support 25 can pivot to its operational position without the instrument panel 18 nor the dashboard 15 preventing the full range of motion or pivotal range 29 for the support plate 26 and attached portable device 19 mounted on the device supports (see device supports 25, 35 and 45).

FIG. 2B is a perspective illustration of a second example portable device holder 30 in its operational position with the portable device 19 (i.e., prior art cellular phone) mounted to a portable device support means 35 (hereafter “device support 35”) comprising a pair of spring-loaded gripping arms 34a and 34b mounted to a support plate 36. As illustrated in this example, the pivotal hinge 22 and attachment means 21 can be the same as shown for the portable device holder 20 seen in FIGS. 1 and 2A. The spring-loaded gripping arms 34a and 34b can use one or more springs (not shown) to respectively produce a rightward biasing force 37a (hereafter “biasing force 37a”) and a leftward biasing force 37b (hereafter “biasing force 37b”). As illustrated the biasing forces 37a and 37b combine to pull the spring-loaded gripping arms 34a and 34b, respectively inward to grip the sides of the portable device 19. The mechanisms for producing the biasing forces 37a and 37b are well known and can include, but are not limited to, one or more metal springs, one or more elastic bands, gravity induced gripping (weight of phone produces the biasing forces 37a-b), etc. The spring-loaded gripping arms 34a-b and support plate 36 can be sized so that the portable device 19 can also be gripped when rotated ninety degrees to a vertical orientation (i.e., portrait). The foam pad 28c can have adhesive on both its top and bottom surfaces to allow bond to the attachment panel 24 and also to the top of an automobile steering column, such as, the steering column surface 14a or dashboard surface 16a. In this way, the gap between the steering column and dashboard becomes less important as the portable device holder 30 can be bonded directly to the top of the steering column surface 14a (see FIG. 1) or bonded to the mounting surface 14. In alternate embodiments, the double-sided adhesive foam pad 28c can bond to the top of the attachment panel 24 and then to the underside of the dashboard 15 on the mounting surface 16. Again the gap between the mounting surfaces 14 and 16 becomes less important as the portable device holder 30 can be bonded to the mounting surface 16 without significant contact with the mounting surface 14 and/or the steering column 10. In many embodiments, the foam pad 28c can be made of a resilient polymer that allows the foam pad to provide a restoring force against the mounting surfaces 14 and 16 similar to the foam pads 28a-b to help hold it in place during use.

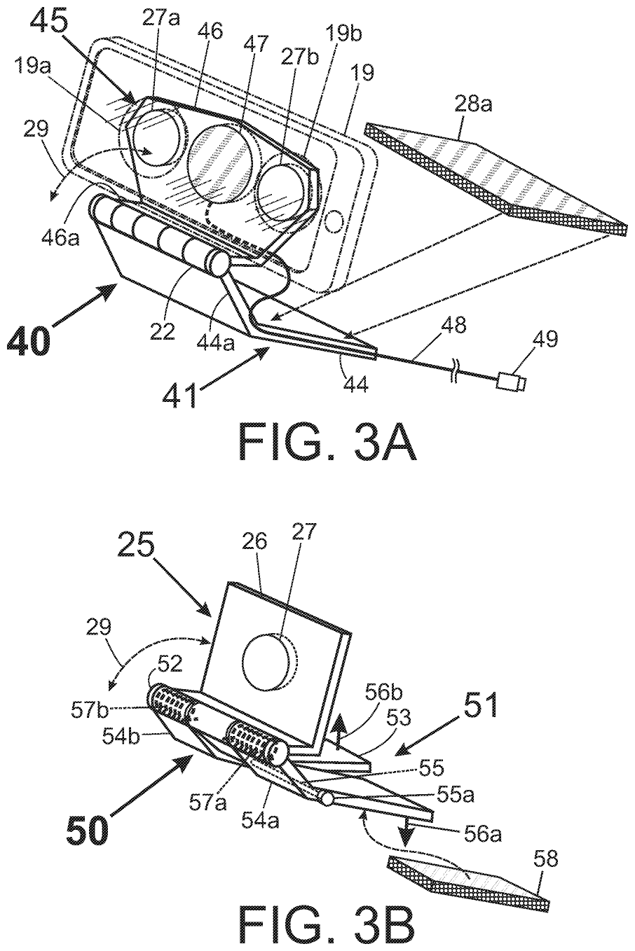

FIG. 3A is a perspective illustration of a third example portable device holder 40 in its operational position. The portable device holder 40 can comprise the pivotal hinge 22, a removable attachment means 41, and a portable device support means 45 (hereafter “device support 45”). The removable attachment means 41 (hereafter “attachment means 41”) can comprise an angled section 44a and an attachment panel 44 which can be designed to be removably mounted in the gap between the mounting surfaces 14 and 16 (see FIG. 1). The attachment means 41 can be constructed and function similar to the attachment means 21. The pivotal hinge 22 can be the same as seen in other portable device holders presented herein. The angled section 44a is longer than the angled section 24a seen on the portable device holder 20, and can extend the pivotal hinge 22 further away from a gap formed by a particular motor vehicle's steering column and dashboard when needed. In some embodiments, the angled sections 24a and 44a can be length adjustable or telescoping to allow an optimum offset distance for the pivotal hinge 22 from the gap formed by that particular motor vehicle's steering column and dashboard. Various prior art methods can be implemented to provide angled section 24a and 44a with the functionality of having an adjustable length. The angled section 44a, is longer than angled section 24a in this example to illustrate how the pivotal hinge 22 may be positioned further away from both the top of the steering column and the front of the instrument panel on that particular motor vehicle's steering column and dashboard, respectively. The angled section 44a can be attached to the attachment panel 44 at about ninety and one hundred sixty degrees, with angles of about one hundred twenty degrees working well in most vehicles.

As illustrated in FIG. 3A, the device support 45 can comprise a pair of magnetic connectors 27a-b, a support plate 46, a wireless charger 47, a Universal Serial Bus cord 48 (hereafter “USB cord 48”) with a Universal Serial Bus plug 49 (hereafter “USB plug 49”). The support plate 46 can be pivotally attached to the attachment means 41 with the pivotal hinge 22. The wireless charger 47 can comprise any prior art or future wireless charger that has a compatible collector antenna (not shown) within the portable device 19 as is presently common on some brands and models of smartphones and electronic tablets. The wireless charger 47 receives power through the USB plug 49 and USB cord 48. The USB cord 48 can be attached to the support plate 46 and/or attachment panel 44. In some embodiments, the USB cord 48 can be molded into the support plate 46, pivotal hinge 22 and/or attachment panel 44. The USB plug 49 can be plugged into a USB port (not shown) found on most new motor vehicles to provide power to the wireless charger 47. The magnetic connectors 27a-b interact with the metal plates 19a-b, that can be mounted on the portable device 19 to temporarily attach the portable device 19 to support plate 46. In some embodiments, the portable device 19 automatically may begin wireless charging with the wireless charger 47 when the portable device 19 is removably mounted as illustrated in FIG. 3A. For proper operation, the metal plates 19a-b should be positioned on the portable device 19 so they do not interfere with the wireless charger 47. The wireless charger 47 can be easily incorporated into other embodiments of the disclosed portable device holder.

FIG. 3B is a perspective illustration of a fourth example portable device holder 50 in its operational position. The portable device holder 50 can comprise a removable attachment means 51 (hereafter “attachment means 51”), a pivotal hinge 52 and the device support 25 (“portable device support means”) discussed previously. The attachment means 51 can comprise a right biasing spring 57a and a left biasing spring 57b, a center attachment arm 53, a right attachment arm 54a, a left attachment arm 54b and a locking pin 55 with a grip head 55a. The device support 25 can be the same as discussed previously and designed to removably hold nearly any portable electronic device. The pivotal hinge 52 can be similar to the pivotal hinge 22 previously discussed, but may include the right and left biasing springs 57a-b within its structure.

The attachment means 51 can be designed for removable mounting in the gap between an automobile's steering column and dashboard (i.e., mounting surfaces 14 and 16, see FIG. 1). As in previous examples, the device support 25 can pivot through the pivotal range 29 to allow a portable device to be pivoted between the stowed position (FIG. 1) and the operational position as illustrated in FIG. 3B without effecting the positions of the attachment arms 53 and 54a-b. As illustrated, the center attachment arm 53 is biased in the opposite direction from the right and left attachment arms 54a-b with the right and left biasing springs 57a-b, respectively. The left and right biasing springs 57a-b produce corresponding biasing forces 56a and 56b on the attachment arms 54a-b and 53 respectively. The biasing forces 56a-b can be used to secure the attachment means 51 between the mounting surfaces 14 and 16. This spring nature of the attachment arms 54a-b and 53 can hold the portable device holder 50 and any attached portable device (i.e., portable device 19) in place during use within a motor vehicle. Though not illustrated in FIG. 3B, the left attachment arm 54b can produce a biasing force with a similar direction to the biasing force 56a seen on the right attachment arm 54a. In alternate embodiments, the right and left biasing springs 57a-b can be reversed (i.e., the center attachment arm 53 is forced downward). In other embodiments a single biasing spring can be used to bias the center attachment arm 53 away from the right and left attachment arms 54a-b.

In some embodiments, the locking pin 55 can comprise a grip head 55a and can be spring loaded to move toward the center attachment arm 53. The grip head 55a allows the user to pull the locking pin 55 outward for inserting it into a hole or notch (not shown) on the side of the center attachment arm 53. This hole or notch on the side of the center attachment arm 53 is not shown here because it would be obscured by the right biasing spring 57a. When the center attachment arm 53 is aligned with the right and left attachment arms 54a-b, the locking pin 55 can be slid into this hole or notch in the side of the center attachment arm 53 to hold the three attachment arms 53, 54a and 54b substantially in alignment with each other. This alignment of the three attachment arms 53, 54a and 54b can allow easier insertion of the attachment means 51 between the gap formed by an automobile's steering column and dashboard (e.g., gap between the mounting surfaces 14 and 16 in FIG. 1). After the attachment means 51 is inserted into this gap, the locking pin 55 can be disengaged by the user pulling outward on grip head 55a. With the locking pin 55 disengaged the center attachment arm 53 is free to pivot away from the right and left attachment arms 54a-b and the right and left biasing springs 57a-b forcing the center attachment arm 53 against the underside of the dashboard (e.g., mounting surface 16) and the right and left attachment arms 54a-b against the top surface of the steering column (e.g., mounting surface 14). In other embodiments, alternative structures besides the pivotal attachment arms 53 and 54a-b can be used to create the biasing forces 56a-b to secure the portable device holder 50 in place during use.

The pivotal hinges 22 and 52 can comprise a friction mechanism that defines multiple positions that the hinge tends to hold, thereby allowing the disclosed device supports 25, 35 and 45 to remain securely in the stowed position (FIG. 1), the operational position (FIGS. 2A-B, 3A-B), and/or additional positions between or beyond these two positions. In some embodiments, the pivotal hinges 22 and 52 can comprise a smooth resistance to motion that tends to slow the motion of the disclosed device supports when being moved to a particular position by the user. In other embodiments, the pivotal hinges 22 and 52 can comprise a friction means that resists rotation unless the user applies sufficient torque to change its position (also called a torque hinge). In other embodiments, the pivotal hinges 22 and 52 can be a simple hinge that rotates when any torque is applied. In still other embodiments, the pivotal hinges 22 and 52 can comprise a detent hinge with two or more specific holding positions which can include, but is not limited to, a stowed position and an operational position. In embodiments where the pivotal hinge 22 or 52 is a simple hinge (i.e., substantially no friction), the stowed position (FIG. 1) can be maintained by the weight of the portable device 19 tending to rotate the pivotal hinge 22 or 52 until the portable device 19 rests on the upper steering column surface 14a of the steering column 10. Similarly, with the pivotal hinge 22 or 52 comprising a simple hinge, the operational position (FIGS. 2A-B, 3A-B) can be maintained because the center of weight of the portable device 19 is offset behind the axis of the pivotal hinge 22 or 52 and toward the automobile's dashboard by the angled sections 26a, 36a and 46a. The angled sections 26a, 36a and 46a can move the center of mass of the portable device 19 plus its device support (i.e., weight of portable device 19 plus the weight of the device supports 25, 35 and/or 45) behind the axis of rotation of the pivotal hinges 22 and 52 so that the pivotal hinge tends to rotate backward to the operational position due to gravity. In some embodiments, this tendency to rotate backward to the operational position can be stopped by the pivotal hinge itself and/or the front surface of the automobile's dashboard in which the portable device holder is installed, or a pivotal stop built into the device holder itself Each of these stops give the removably attached portable device 19 a stable operational position (e.g., FIGS. 2A, 2B, 3A and 3B and a stable stowed position (e.g., FIG. 1).

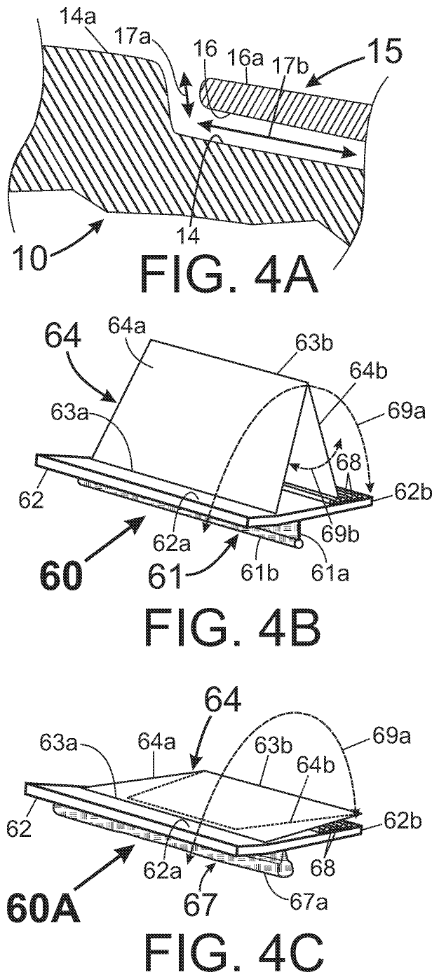

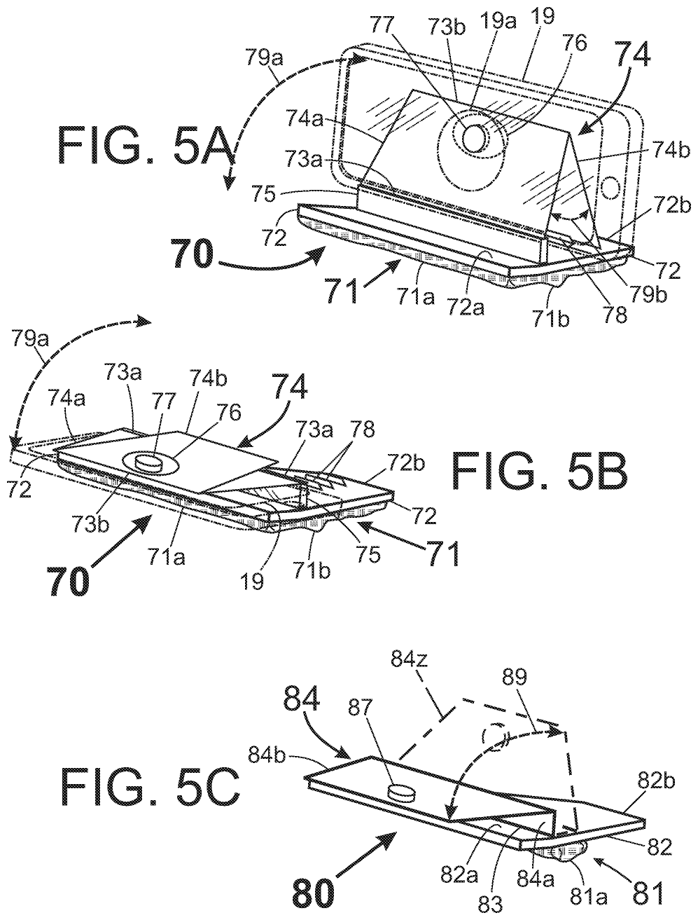

FIG. 4A is an illustrative cross-sectional view of the gap between the steering column 10 and dashboard 15 seen in FIG. 1. Notice that the gap defines a vertical channel 17a, a horizontal channel 17b and an angled transition between them. As illustrated, and discussed previously, the disclosed portable device holders 20, 30, 40 and 50 mostly use the horizontal channel 17b, with its interior mounting surfaces 14 and 16, to grip and hold the attachment panels 24 and 44, and the attachment arms 54a-b and 53 (plus any attached foam pads 28a-c and 58). In some situations, the can also interact with the vertical channel 17a to help hold these portable device holder in place during use. The disclosed portable device holders 20, 30, 40 and 50 may also use the vertical channel 17a to help stabilize these portable device holders through interaction of the angled sections of attachment arms 53 and 54a-c, the angled section 24a and/or the pivotal hinges 22 and 52 with the surfaces within the vertical channel 17a (e.g., the angled surface between steering column surface 14a and mounting surface 14) and/or the steering column surface 14a near the vertical channel 17a. One or more foam pads 58 (hereafter “foam pad 58”) can be attached to the left and right attachment arms 54a-b and center attachment arms 53 (see FIG. 3B) to adjust the thickness of these attachment arms and provide a better grip against the mounting surfaces 14 and 16 (i.e., the horizontal channel 17b). The left and right attachment arms 54a-b, and similar angled center attachment arm 53, can define an angled section within the attachment means 51 with about a ninety to one hundred sixty degree angle, with angles of about one hundred twenty degrees working well in most vehicles. However, in many situations most of the securing and stabilizing forces can come from interaction of the portable device holders 20, 30, 40 and 50 with the mounting surfaces 14 and 16 (i.e., horizontal channel 17b). In the following alternative embodiments seen in FIGS. 4B through 5C, the upper steering column surface 14a, the dashboard surface 16a, and the vertical channel 17a can provide the majority of the stabilizing force for the disclosed removable attachment means. In FIGS. 4B through 5C, the horizontal channel 17b can provide a portion of the holding force for securing the following portable device holder in place during use.

In the following examples, the portable device holders are not locked in place as seen in the previous examples where the steering column 10 can be moved to compress the attachment panels 24 and 44, and attachment arms 54a-b, and any attached foam pads 28a-c, between the mounting surfaces 14 and 16. Instead, the interior surfaces or side walls of the vertical channel 17a can provide some of the support surfaces for the portable device holders to help hold the following example portable device holders in place during use. The upper steering column surface 14a and/or dashboard surface 16a can also be used to stabilize these example portable device holders. Thus, the majority of the securing and holding forces for the portable device holders seen in FIGS. 4B through 5C, come from the weight of the portable device holder and any attached device, and the friction caused by their weight. In the following embodiments, the removable attachment means can extend through the vertical channel 17a (see FIGS. 4B through 5C) and sometimes partially into the horizontal channel 17b to hold the portable device holder (see FIGS. 4B, 4C and 5C) in place within a vehicle.

FIG. 4B is a perspective illustration of a fifth example portable device holder 60, in its operational position. The portable device holder 60 can comprise a base plate 62, a portable device support means 64 (hereafter “support panel 64”) and a removable attachment means 61. The base plate 62 can comprise a front portion 62a, a rear portion 62b and a plurality of ridges 68 defined on the rear portion 62b. An underside surface of the base plate 62 may be considered part of the removable attachment means 61 because the underside surface will tend to rest on the steering column surface 14a and dashboard surface 16a and help hold the portable device holder 60 in place. Thus, the underside of the base plate 62 can be covered with a rubberized, compliant and/or high-friction material or structure to help provide a slip resistant surface for the base plate 62 to rest on and thereby help stabilize the portable device holder 60 during use.

The support panel 64 can comprise a front support panel 64a and a rear support panel 64b. In some embodiments, the base plate 62 can be formed from a single sheet of material comprising, but not limited to, a rubberized sheet, a cardboard sheet, a wood panel, a plastic panel, a foam board sheet, a composite panel, injection molded part, etc. In at least one embodiment, the base plate 62 can be shaped so that the rear portion 62b is significantly narrower (i.e., narrow left or right) than the front portion 62a. This is to allow the rear portion 62b to fit within a particularly narrow center cavity on some dashboards. For example, on many automobile dashboards, an instrument panel cavity is placed directly above the steering wheel with an instrument panel (e.g., instrument panel 18) at the bottom of this cavity to block glare. Thus, the dashboard surface 16a, in some vehicles, may only be a few inches wide to accommodate the rear portion 62b. Thus, in some embodiments, the rear portion 62b can be shaped with a narrow width to allow the rear portion 62b to rest on the dashboard surface 16a of most motor vehicles. The plurality of ridges 68 can be mounted on the rear portion 62b to provide multiple positions for the free end of the rear support panel 64b. This allows for multiple positions for the support panel 64 and multiple angles for front support panel 64a, which in turn allows the user to select multiple viewing angles for their portable device 19 or other portable device that rests on the front surface of the front support panel 64a.

The front and rear support panels 64a and 64b, can consist of a stiff sheet material, such as, a cardboard sheet, a wood panel, a plastic panel, a foam board sheet, a composite panel and/or other materials that can be constructed into a flat panel like structure. The front support panel 64a can be pivotally attached to the base plate 62 at a front hinge 63a. A top edge of front support panel 64a can be pivotally attached to rear support panel 64b at an upper hinge 63b. The upper hinge 63b allows the support panel 64 to fold and unfold near its middle with an example range of motion shown by a range of motion line 69b. As illustrated, the support panel 64 can be pivotally attached at its front end with the front hinge 63a and can have about a one-hundred eighty degree range of motion as shown by a range of motion line 69a. In some embodiments, the support panel 64 can consist of a single piece of material with front and upper hinges 63a and 63b comprising a “living hinge” formed into the support panel 64 and attached to the base plate 62 at the front hinge 63a. In other embodiments, the front and upper hinges 63a and 63b, respectively, can comprise a flexible hinge material, which can comprise but are not limited to, a thin polymer tape, a fabric material, a hinge with center pin (see pivotal hinge 22) and other types of hinge systems.

The removable attachment means 61 can comprise a flexible support 61a and a hanging weight 61b and optionally a high-friction coating (e.g., a rubberized coating) on the underside of the base plate 62. The flexible support 61a can be a fabric strip or other flexible sheet material that is attached to the underside of the base plate 62 at one end and attached to the hanging weight 61b on the other end. The hanging weight 61b can comprise a dense material that might be sewn into the flexible support 61a. In some embodiments, the hanging weight 61b can comprise a metal bar or rod (i.e, steel, lead, copper, etc.), a dense rubber or sand filled polymer that is relatively dense and can be held by the flexible support 61a. In some embodiments, the flexible support 61a can be optional and the hanging weight 61b bonded directly to the underside of the base plate 62. The Portable device holder 60 is shown in its operational position in FIG. 4B without an attached portable device (see FIG. 2A) to keep the drawing uncluttered and readable. For use, the portable device 19 can rest on the front portion 62a and leaned against the front support panel 64a in a manner similar to that illustrated in FIG. 2A where the portable device 19 rests on the angled section 26a and leans against the device mounting surface 26b. The portable device 19 can be held in place by its own weight while resting on the front portion 62a and the front surface of the front support panel 64a. In some embodiments, the front portion 62a and the front support panel 64a can have a non-slip coating or surface, which can comprise, but is not limited to, a rubberized coating, a textured surface, a soft or conformable surface, or other means to prevent the portable device 19 from slipping off of the front portion 62a during use (i.e., slipping off its operational position). In other embodiments, the magnetic connector 27 can be incorporated into the front support panel 64a to temporarily secure the portable device 19 with metal plate 19a to the portable device holder 60 (similar usage as seen in FIG. 2A).

As illustrated in FIG. 4B, the lower edge of the rear support panel 64b can be selectively positioned between the plurality of ridges 68 to provide adjustability of the angle of front support panel 64a. The lower edge of the rear support panel 64b does not need to be attached to the plurality of ridges 68, instead the weight due to gravity on the support panel 64 and any portable device resting on front support panel 64a can provide sufficient force to hold the lower end of the support panel 64b in place against the plurality of ridges 68 during use. For storage, the rear support panel 64b can be folded against the front support panel 64a using the upper hinge 63b (see the range of motion line 69b). Then, the front and rear support panels 64a-b can be folded either forward (see FIG. 5B) or backward (see FIG. 4C) and out of the user's view. With the support panel 64 folded flat (see stowed support panel 64 in FIG. 4C and also support panel 74 in FIG. 5B), the support panel 64 is effectively moved out of the user's view of the instrument panel 18 (e.g., the speedometer gauge, etc.). Thus, when the portable device holder 60 is not being used it can be stowed so as to not obstruct the user's view of the vehicle's instrument panel 18. In other embodiments, the support functions provided by the rear support panel 64b (supporting and angling the front support panel 64a) can be achieved in many alternate ways. For example, in some embodiments, the rear support panel 64b might be connected to the base plate 62 with a living hinge instead of front support panel 64a and the front support panel 64a could move to adjust the angle of its front surface with the plurality of ridges 68 moved to the front portion 62a so that the unsecured bottom edge of the front support panel 64a can engage the plurality of ridges 68 and provide a stable resting surface for a portable device such as the portable device 19. To stow such a system, the front support panel 64a can be folded under the rear support panel 64b (see range of motion line 69b) and then both panels folded forward against the front portion of the base plate 62 (where the plurality of ridges 68 would now reside). In other embodiments, various other support means can be used to prop up the front support panel 64a at the desired angle for operation. In at least one embodiment, the front support panel 64a can have only a single operational position (i.e., no adjustable angle).

FIG. 4C is a perspective illustration of a sixth example portable device holder 60A, in its stowed position. The portable device holder 60A can comprise the base plate 62 and the support panel 64 previously seen in FIG. 4B. The portable device holder 60A can also comprise a removable attachment means 67 attached to the underside of the base plate 62. The removable attachment means 67 can comprise a conformable weighted bag 67a filled with a granular material (not seen within the conformable weighted bag 67a) which may comprise, but are not limited to, a sand mixture, a bean mixture, a lead shot mixture, a rock mixture and a soil mixture. The nature of the granular material within the removable attachment means 67 allows the removable attachment means 67 to be shaped by the user to substantially conform to the contours of the vertical channel 17a in order to securely hold the portable device holder 60A in place. In some embodiments, the removable attachment means 67 can comprise a larger or a smaller conformable bag for use in various motor vehicles with a larger or smaller vertical channel compared to the vertical channel 17a. In other embodiments, the removable attachment means 67 can include a rubberized coating on the underside surface of the base plate 62 to help grip the automobile's steering column surface 14a and dashboard surface 16a. In other embodiments, the base plate 62 can be a flexible panel that can conform to the shape of the steering column surface 14a and/or the dashboard surface 16a (hereafter collectively “surfaces 14a and 16a”).

FIG. 5A-B is a perspective illustration of a seventh example portable device holder 70, in its operational and stowed positions respectively. The portable device holder 70 can comprise a base plate 72, a vertical panel 75, a portable device support means 74 (hereafter “support panel 74”) and a removable attachment means 71. The base plate 72 can comprise a front portion 72a, a rear portion 72b and a plurality of tabs 78 defined on the rear portion 72b. The support panel 74 can comprise a front support panel 74a, a rear support panel 74b, a securing magnet 77 (i.e., a magnetic connector) mounted on the front support panel 74a and a hole 76 defined on the rear support panel 74b to allow space for the securing magnet 77 when the support panel 74 is folded closed for stowage (see FIG. 5B).

In some embodiments, the base plate 72 can be formed from a single sheet of material. The base plate 72 can comprise, but not limited to, a rubberized sheet, a cardboard sheet, a wood panel, a plastic panel, a foam board sheet, a composite panel, etc. In at least one embodiment, the base plate 72 can be shaped so that the free end of the rear portion 72b is significantly narrower than the front portion 72a (see FIG. 5B). A narrow width for the rear portion 72b can allow it to more easily fit within a narrow cavity found on some dashboard instrument panels. In some embodiments, the rear portion 72b can be wedge shaped with a narrow width to the rear to allow the rear portion 72b to be positioned over the dashboard surface 16a in most motor vehicles. The plurality of tabs 78 can be formed on the rear portion 72b to provide multiple positions for the free end of the rear support panel 74b to engage and hold the support panel 74 at multiple stable positions. The plurality of tabs 78 can allow the angle of the front support panel 74a to be adjusted, which in turn allows the user to select a desirable viewing angle for their portable device 19 or other portable device when resting on the front surface of the front support panel 74a.

The vertical panel 75 can comprise a stiff sheet or panel made from nearly any structural material such as cardboard, plastic, wood, composites, metal, etc. The vertical panel 75 can be bonded to the top surface of base plate 72 to provide a raised position for pivotal attachment of the support panel 74. In some embodiments, the vertical panel 75 and base plate 72 can be made from a single injection molded piece of plastic or other polymer, rubber, elastomer, etc. The front and rear support panels 74a and 74b of support panel 74 can be comprised of a relatively stiff material similar to front and rear support panel 64a and 64b. The front support panel 74a can be pivotally bonded to the top of vertical panel 75 at a front hinge 73a. A top edge of front support panel 74a can be pivotally bonded to the rear support panel 74b at an upper hinge 73b. The upper hinge 73b allows the support panel 74 to fold and unfold near its middle with an example range of motion shown by range of motion line 79b. As illustrated, support panel 74 can pivot forward and backward around the front hinge 73a and can have about a one-hundred eighty degree range of motion as shown by range of motion line 79a. In some embodiments, the support panel 74 might pivot only forward or backward from its operational position (i.e., FIG. 5A). The height of the vertical panel 75 can be selected to allow sufficient space for the portable device 19, or other portable device, to be secured to the front surface of the front support panel 74a with the securing magnet 77 and then be pivoted forward for stowage as shown in FIG. 5B. For ergonomic operation, the bottom portion of the portable device 19, or other portable device, can be placed slightly above the front hinge 73a to allow folding to the stowed position seen in FIG. 5B without binding against the vertical panel 75. In some embodiments, the front support panel 74a can include a support ledge (not shown) near the front hinge 73a for resting the portable device 19 on with sufficient spacing to prevent binding against the vertical panel 75. In some embodiments, the support panel 74 can consist of a single piece of material with the front and upper hinges 73a and/or 73b comprising a “living hinge” formed into the support panel 74 itself and attached to the vertical panel 75 with the lower hinge 73a. In alternate embodiments, the support panel 74 and vertical panel 75 can comprise a single piece of material with front and upper hinges 73a and/or 73b comprising a “living hinge” formed into that structure. In other embodiments, the front and upper hinges 73a and 73b, respectively, can comprise a flexible material, which can comprise, but are not limited to, a polymer tape, a fabric material, a flexible polymer and/or other flexible and fatigue resistant materials.

The removable attachment means 71 can be attached to a bottom portion of the base plate 72 and comprise a conformable weighted bag 71a with an enlarged section 71b. The conformable weighted bag 71a and enlarged section 71b can form an enclosure that can be filled with a granular material. The removable attachment means 71 can be bonded or otherwise attached to the underside of the base plate 72. The conformable weighted bag 71a can comprise a woven fabric made from fibers comprising materials such as, but not limited to, cotton, nylon, polyester and polypropylene. The conformable weighted bag 71a can form a structure similar to a bean bag on the underside of base plate 72. In some embodiments, the conformable weighted bag 71a can comprise a single sheet of fabric that is bonded near the edges of the underside of base plate 72 to enclose the granular material. The conformable weighted bag 71a can be filled with granular material to provide a conformable surface for the bottom of the portable device holder 70 which the user can adjust to conform to the shape of the upper steering column surface 14a, lower dashboard surface 16a and the vertical channel 17a between the surfaces 14a and 16a. The granular material placed within the conformable weighted bag 71a an comprise various materials, such as, sand, dried beans, pebbles, glass beads, lead shot, rocks, gravel, and other materials that can be formed into small particles. In some embodiments, the conformable weighted bag 71a can be filled with a conformable gel or clay that can conform to various motor vehicle surfaces. In some embodiments, the conformable weighted bag 71a can optionally include an enlarged section 71b which is designed to extend down into the vertical channel 17a of a motor vehicle. The portable device holder 70 is shown in its operational position in FIG. 5A and its stowed position in FIG. 5B, with the prior art portable device 19 attached and shown in shadow lines. The portable device 19 can be held in place by the securing magnet 77 on the front support panel 74a interacting with the metal plate 19a mounted on the portable device 19 (see FIG. 2A). In some embodiments, the portable device 19 can be held in place by gravity alone. As illustrated, the front surface of the front support panel 74a can have a non-slip coating or surface, which can comprise, but are not limited to, a rubberized coating, a textured surface, a soft or conformable surface, or other means to help prevent the portable device 19 from slipping off of support panel 74 during use or stowage.

FIG. 5B illustrates the portable device holder 70 seen in FIG. 5A in its stowed position. The ability to securely mount the portable device 19 to the front support panel 74a with the securing magnet 77 allows the user the option of simply pivoting the portable device 19 down, around the front hinge 73a, when not being used. Pivoting the portable device 19 down, as illustrated, can stow the phone face down against the front portion 72a of base plate 72 and/or the steering column surface 14a or other upper surface of steering column 10. With the support panel 74 folded closed (i.e., down, as illustrated in FIG. 5B), the support panel 74 is effectively out of the user's line of view to the instrument panel 18 (e.g., the speedometer gauge, etc.). Further, because the portable device 19 is magnetically attached to the support panel 74 by securing magnet 77, the portable device 19 also folds out of the user's line of sight when the portable device holder 70 is in its stowed position, but remains attached to the support panel 74. This makes it extremely easy for the user to move the portable device 19 between its stowed position seen in FIG. 5B and its operational position seen in FIG. 5A and back again. In other embodiments, the function provided by the rear support panel 74b in selecting the angular position of the front support panel 74a can be achieved in many alternate ways. For example, in FIG. 5C an alternate portable device holder obtains the correct angle for its support panel by the shape of the support panel itself, but has only a single operational position in that particular example. In other embodiments, the front hinge 73a can comprise a friction hinge similar to the pivotal hinge 22 and entirely eliminate the need for the rear support panel 74b and plurality of tabs 78. In the portable device holder 70, various other support means can be used to prop-up the front support panel 74a at the desired angle for operation. In some embodiments, the angle of the front support panel 74a can be determined by the range of motion of the front hinge 73a and/or by contact of the portable device 19 with a portion of the instrument panel 18 to stop the backward tilting of the front surface of the front support panel 74a.

FIG. 5C is a perspective illustration of an eighth example portable device holder 80, in a stowed position. The portable device holder 80 can comprise a base plate 82, a portable device support means 84 (hereafter “support panel 84”), a hinge 83 that connects the base plate 82 to support panel 84 and a removable attachment means 81. The base plate 82 can comprise a front portion 82a and a rear portion 82b which can comprise a single structure or panel. The removable attachment means 81 can comprise a conformable weighted bag 81a and an underside surface of the base plate 82. The underside surface of base plate 82 may be considered part of the removable attachment means 81 because the underside surface of the base plate 82 will tend to rest on the steering column surface 14a and dashboard surface 16a and help hold the portable device holder 80 in place. Thus, the underside of the base plate 82 can be covered with a rubberized, compliant and/or high-friction material to help provide a slip resistant surface for the base plate 82 to rest on and thereby help stabilize the portable device holder 80. In this illustration, the conformable weighted bag 81a has a somewhat cylindrical shape to allow it to conform more deeply into the gap between the steering column 10 and dashboard 15 (i.e., the vertical channel 17a). In at least one embodiment, base plate 82 can comprise a flat panel made of a rigid or semi-rigid material. Some of the materials that the base plate 82 can comprise, can include but are not limited to cardboard, plastic, composites, wood, metal, rubber (i.e., rubber mats), and other sheet materials and coatings. In some embodiments, base plate 82 can have a contoured shape that makes it easier to conform to specific automobile steering columns and dashboards. In the case where the base plate 82 comprises a heavy flexible rubber mat-like material, the base plate 82 can itself act as a major part of the securing means by wrapping and conforming to the automobile's steering column surface 14a and dashboard surface 16a to secure the portable device holder in place during use. Thus, in some embodiments, the conformable weighted bag 81a can be optional. In other embodiments, the heavy flexible rubber mat material can also comprise a protrusion on the underside of the base plate 82 that can fit into the vertical channel 17a to further help hold the portable device holder 80 in place during use.

As illustrated, the support panel 84 can comprise an “L” shape injection molded part with a lower panel 84a and an upper panel 84b. As an option, the upper panel 84b can also comprise a securing magnet 87 (i.e, a magnetic connector). In some embodiments, the support panel 84 can be made from various material, including, but not limited to, a cardboard, a composite, a metal alloy, a wood, a moldable polymer, a polymer sheet, etc. In at least one embodiment, the lower and upper panels 84a and 84b respectively can comprise separate pieces that are attached to one another through glues, adhesives, welding, snap fit, sonic welding or one of the many other bonding methods used in prior art. The lower and upper panels 84a and 84b can support the portable device 19 similar to how the front portion 62a and front support panel 64a, respectively, provide support for the portable device holders 60 and 60A seen in FIGS. 4B and 4C respectively. However, because the support panel 84 can pivot as a single unit around the hinge 83, the portable device 19 can stay in constant contact with both the lower panel 84a and an upper panel 84b in both the stowed position shown and an operational position 84z in shadow lines. In some embodiments, the lower panel 84a can have a front lip to further help hold the portable device 19 in place. In other embodiments, lower and upper panels 84a and/or 84b can comprise a high-friction coating to further help hold the portable device 19 in place during use and in stowage. The operational position 84z (shown in shadow lines) for support panel 84 can be maintained by gravity when the backside of the lower panel 84a contacts the base plate 82. As illustrated, the angle between the lower panel 84a and upper panel 84b can determine the angle of upper panel 84b in its operational position 84z and thus the angle at which the portable device 19 is viewed when attached to the securing magnet 87. With a sufficient angle to upper panel 84b, gravity alone can be used to hold the portable device 19 and support panel 84 in its operational position 84z during use. Similarly, gravity alone can hold the support panel 84 and any attached portable device in the shown stowed position. In alternative embodiments, the support panel 84 can further include a latch that temporarily secures the support panel 84 in its operational position 84z, but then can release to place it in its stowed position as illustrated.

Apart from the operational characteristics of the disclosed portable device holders 20, 30, 40, 50, 60, 70 and 80 for holding the illustrated portable device 19, the disclosed portable device holders 20, 30, 40, 50, 60, 70 and 80 can also hold other small portable devices including, but not limited to, a smartphone, a cellular phone, an electronic communication device, a satellite phone, an electronic tablet, a kindle tablet, a picture frame, an electronic picture frame, a small dry erase board for taking notes, and etc.

### Operational Description

The portable device holders presented in FIGS. 1 through 5C can be installed within a variety of automobiles and motor vehicles with various steering column and dashboard constructions. This is because nearly all motor vehicles require a space to exist between their dashboard and their steering column to allow for movement of the motor vehicle's suspension and drive train. Furthermore, almost all new motor vehicles (i.e., automobiles, trucks, vans, etc.) can allow the steering wheel 13 to be adjusted by moving the upper portion of the steering column 10. Thus, nearly all motor vehicles have a gap between their steering column and dashboard of between about one-quarter inch to two inches, which can be used to secure the disclosed portable device holders 20, 30, 40 and 50 using resilient foam pads 28a-c and 58 to fill these gaps as needed. The use of spring-loaded attachment arms 54a-b and/or 53 to create an outward holding force against the mounting surfaces 14 and 16 can also be used. These are but a few examples of how the gap between the steering column 10 and dashboard 15 can be used to secure a device holder and keep it in place during use of the motor vehicle. Besides the gap between the steering column 10 and dashboard 15, most motor vehicles also have a somewhat flat surface on top of the steering column 10 and/or dashboard 15 (e.g., the steering column surface 14a and dashboard surface 16a) that a particular portable device holder can rest on. Thus, the portable device holders 60, 60A, 70 and 80 can be placed on the surfaces 14a and 16a and be securely held in place by their own weight, the friction between surfaces and the weight of any portable device resting on the portable device holders.

The portable device holders 20, 30 and 40, as illustrated in FIGS. 1 through 3A can be installed in most motor vehicles using a simple three step process: 1) lowering the motor vehicle's steering column (i.e., for adjustable steering wheels) to create an increased gap between the steering column 10 and dashboard 15, 2) inserting the device holder's removable attachment means 21 into the increased gap created, 3) raising the motor vehicle's steering column until the attachment means 21 is snugly trapped between the steering column's interior mounting surface 14 and the dashboard's interior mounting surface 16. The variations in the size of the gap width between the steering column 10 and dashboard 15 can require the use of one or more foam pads 28a-b or other resilient materials to adjust for the gap width. Similarly, the user's preference on the location of the motor vehicle's steering wheel while driving can require one or more foam pads 28a-b or other resilient materials to be used to adjust the vertical position of the attachment means 21, 41 and 51 at the correct height with respect to the gap and allow an attached smartphone, or other portable device, to pivot between the stowed position and the operational position. Thus, the user can determine the positions for the foam pads 28a-b (which may be stacked to create larger thicknesses) to both fill the gap (for snug fit) for the desired vertical placement of the steering wheel 13 and provide the desired vertical position for the attachment means 21 with respect to the steering column 10.

The user can estimate the thickness of the foam pads that is needed to secure the attachment means 21, 41 and 51 between the mounting surfaces 14 and 16 for the user's desired placement of the vehicle's steering wheel (e.g., steering wheel 13) by: 1) placing the bare attachment panel 24 in the gap, 2) moving the steering column back to the user's preferred position, 3) estimating the needed thickness of the foam pads for the top and bottom surfaces of the attachment panel 24 to maintain the desired position of the portable device holder 20 during driving and 4) peeling and sticking the foam pads 28a-b on the top and bottom surfaces of the attachment panel 24 until the desired thicknesses are reached. The foam pads 28a and 28b can comprise a peel and stick adhesive backed foam pad, so the user can easily peel off the protective film and attach the foam pads 28a and/or 28b or portions of these foam pads (cut to desired size with scissors) to the attachment panel 24 and also attach other foam pads 28a and/or 28b in a similar way to those foam pads 28a and/or 28b already attached to the attachment panel 24. In general, several thicknesses of the adhesive backed foam pads 28a and 28b can be provided to the user to allow them to adjust the thickness of the foam padding over a wide range of thicknesses both above and below the attachment panels 24 and 44. In this way the user may be able to simply use one or two selected thicknesses for the foam pads 28a and/or 28b on the top and bottom of attachment panels 24 and 44 to achieve the desired positioning. In some embodiments, the thicknesses of the foam pads can include, but are not limited to, 1/16 inch, ⅛ inch, ¼ inch and ½ inch, and other thicknesses can be used. In each of the portable device holders 20, 30 and 40 the user can bond as many foam pads as needed to reach the desired thickness on the top and bottom surfaces of the attachment panels 24 and 44.

In some older style motor vehicles the steering wheel is not adjustable (upper steering column not adjustable). For these older style motor vehicles the portable device holder 50, as illustrated in FIG. 3B can be effectively installed in these older style motor vehicles without having to move the motor vehicle's steering column. The reader should note that the portable device holder 50 can be installed in both styles of motor vehicles using a simple three step process: 1) locking the attachment means 51 in its inline position with the locking pin 55 (attachment arms 53 and 54a-b locked in the same plane), 2) inserting the attachment means 51 between the steering column and dashboard, and 3) releasing the locking pin 55 by pulling on the grip head 55a. After the locking pin 55 has been released, the attachment arms 53 and 54a-b expand away from each other and against the dashboard 15 and steering column 10 respectively. The biasing forces 56a-b can be created by right and left biasing springs 57a-b. The variations within motor vehicles of the size of the gap width between the steering column 10 and dashboard 15 can be accommodated by adding one or more foam pads 58 or other resilient materials to the attachment arms 53 and/or 54a-b to provide the proper fit of the attachment means 51 within the gap. In at least one embodiment the one or more foam pads 58 can be adhesively bonded to the top surface of the center attachment arm 53 and/or the bottom surface of the right and/or left attachment arms 54a-b. In at least one embodiment, the locking pin 55 can be omitted and the user installs the attachment means 51 by compressing the center attachment arm 53 to line up with the right and left attachment arms 54a-b using their fingers and then pushing the three attachment arms into the gap between the motor vehicle's steering column (see steering column 10) and dashboard (see dashboard 15). Once the user releases the spring biasing on the attachment arms 53 and 54a-b, the biasing forces 56b and 56a respectively, push the center attachment arm 53 and the right and left attachment arms 54a-b in the opposite directions. This can result in the attachment means 51 being firmly wedged in the gap between the mounting surfaces 14 and 16.

In order for the portable device holders 20, 40 and 50 to securely hold the portable device 19, one or more metal plates 19a-b can be attached to the portable device 19 or its protective case (not shown but commonly used). For the purposes of this invention the metal plates 19a-b can be considered attached to the portable device 19 if they cannot be pulled free from the portable device 19 by the magnetic forces of magnetic connectors 27 or 27a-b. As such, the metal plates 19a-b can be mounted on the outside of a portable device's protective case (e.g., smartphone case), mounted to the inside of the protective case, inserted unattached between the protective case and the portable device 19 or mounted to the back of the portable device 19. In at least one embodiment the device supports 25 and 45 can comprise placement of the metal plate(s) 19a and/or 19b between the back of the portable device 19 and its protective case (not shown) with friction alone to hold the metal plate(s) 19a and/or 19b in place. In some embodiments, a metal plate can be factory installed into the back of the portable device 19 to provide a metal plate that can be secured to the magnetic connectors 27 or 27a-b.

The portable device holder 30 can securely hold the portable device 19 by the user simply inserting the portable device 19 between the spring-loaded gripping arms 34a and 34b. The biasing forces 37a and 37b press the left and right spring-loaded gripping arms 34a-b inward respectively against the left and right sides of the portable device 19 respectively to hold the portable device 19 or other device in place. Note that if the width of the device support 35 is chosen correctly, the spring-loaded gripping arms 34a-b can grip the portable device 19 in both its landscape orientation (i.e., FIG. 2B) and its portrait orientation (portable device 19 rotated ninety degrees).

After the example portable device holders 20, 30, 40 and 50 are installed between the motor vehicle's steering column and dashboard, and a smartphone or other portable device is attached to their device supports 25, 35, 45 and 25 respectively, then the user can pivot the smartphone or other portable device (e.g., portable device 19) through the pivot range 29 (range of motion) to provide a stowed position (face down against steering column) and an operational position (face toward the user). During use, the portable device holders 20, 30, 40 and 50 in their operational positions (positions in FIGS. 2A through 3B) the driver (the user) can view data on their portable device 19 and press its touch sensitive surface to enter data. When the driver wants a clear view of their automobile's instrument panel 18 they can simply reach forward and pivot the portable device 19 around the device holder's pivotal hinge (e.g., pivotal hinges 22 and 52) to the stowed position (position in FIG. 1) to provide an unobstructed view of the instrument panel 18. Later when the user wants to view data again on their portable device (e.g., portable device 19 or other portable device), they simply pivot the portable device 19 back up into the operational position for viewing. In many embodiments, both the stowed position and the operational position can be designed to be physically stable positions for the portable device 19. This stability can be due to gravity, friction mechanisms in the pivotal hinge 22 or 52, or other pivotal position holding means.

The portable device holder 60, as illustrated in FIG. 4B can be installed by simply placing the hanging weight 61b in the gap (i.e., vertical channel 17a) between the steering column 10 and dashboard 15. The amount of weight used for the hanging weight 61b can be determined by the size of portable device the user plans to place on the portable device holder 60. The underside of the base plate 62 can be rubberized and/or made compliant to provide better grip between the portable device holder 60 and surfaces 14a and 16a and reduce the likelihood of slippage of the base plate 62. The rear support panel 64b can be folded out with its lower end placed selectively into one of the plurality of ridges 68 to provide the desired angle for the front support panel 64a. In some embodiments, the bottom free edge of the rear support panel 64b can comprise a snap structure that has a plurality of corresponding snap grooves defined by the plurality of ridges 68 to allow the bottom portion of the rear support panel 64b to be securely snapped into place against the plurality of ridges 68. The use of such snaps can provide a more stable positioning of both the front and rear support panels 64a and 64b and provide a stable platform to support a portable device. A portable device (e.g., the portable device 19) can be placed on the front portion 62a and leaned back on the front surface of front support panel 64a. In this position, the portable device 19 can be held in place by its own weight and friction against the surfaces of front portion 62a and front support panel 64a. The front portion 62a and front support panel 64a can be coated with a high-friction material to help the portable device to remain in place even during aggressive driving. When not in use, the front and rear support panels 64a-b can be folded flat (see FIG. 4C) to allow the user to view their motor vehicle's instrument panel without obstruction. For reuse, the support panel 64 can be unfolded and returned to the position shown in FIG. 4B. When desired, the portable device holder 60 can be lifted away from the steering column 10 and dashboard 15 and reused in another motor vehicle.

The portable device holders 60A, 70 and 80, as illustrated in FIGS. 4C through 5C can be installed in most motor vehicles using a simple two-step process: A) placing the portable device holder over the gap between the steering column 10 and dashboard 15 and B) wiggling the portable device holder to conform the removable attachment means (e.g., the conformable weighted bags 67a, 71a and 81a respectively) into the vertical channel 17a and/or horizontal channel 17b, and conform to the steering column surface 14a and dashboard surface 16a. In some embodiments, the base plates 62, 72 and 82 can have a contoured shape to help hold them in place against the steering column surface 14a and/or the dashboard surface 16a. The variations in the width of the gap between the steering column and dashboard may be optimized by use of a larger or a smaller weighted bag. In some embodiments, the conformable weighted bags 67a, 71a and 81a can be replaced by other weighted conformable systems that can adjust to the gap width and/or curvature of the surfaces 14a and 16a. Once the conformable weighted bags 67a, 71a and 81a take on the shape of the steering column surface 14a, dashboard surface 16a and the gap between them, the granular nature of the contents of the conformable weighted bags 67a, 71a and 81a can resist movement and thus hold the base plates 62, 72 and 82 respectively in place during use.

The portable device holder 60A, once installed over an automobile's gap between its steering column 10 and dashboard 15, can be wiggled back and forth to shift the conformable weighted bag 67a into the vertical channel 17a. Then the support panel 64 can be folded for stowage and unfolded for use as previously discussed for the portable device holder 60. As illustrated, both portable device holders 60 and 60A can fold their support panel 64 either forward or backward for stowage (backward folding shown in FIG. 4C). In some embodiments, the support panel 64 may fold only forward or only backward. With the support panel 64 positioned as illustrated in FIG. 4B, the portable device 19 can be placed on the front portion 62a and leaned back against the front support panel 64a. Because most steering column are inclined, this placement of the portable device 19 can use gravity to hold the portable device 19 in place. In some embodiments a “grippy” surface for the front portion 62a and front support panel 64a can help the portable device 19 to remain in place even during aggressive driving. These “grippy” surfaces can comprise, but are not limited to, rubberized coatings, soft conforming surfaces, ridges that grip the edges of the portable device 19, textured surfaces and other structures and materials that tend to grip something resting on them. In some embodiments, the front portion 62a and front support panel 64a can be covered with a conformable bag similar to conformable weighted bags 71a so that the portable device 19 or other portable device can be pressed into the conformable bag by the user to hold the portable device 19 or other portable device in place during use.

The portable device holder 70, after being placed over gap between steering column 10 and dashboard 15, can be pressed into place by the user to shape the conformable weighted bag 71a to the steering column surface 14a, the surfaces of vertical channel 17a and dashboard surface 16a. Once conformed to these surfaces, the removable attachment means 71 can hold the portable device holder 70 in place during use. The operation of the portable device holder 70 can be similar to the portable device holder 20, where the support panel 74 can fold and unfold between a stowed position (see FIG. 5B) and an operational position (see FIG. 5A). When folding for stowage, the vertical panel 75 provides space for the portable device 19 to fold face-down against the front portion 72a and/or steering column surface 14a without binding against the vertical panel 75. At the same time, the rear support panel 74b can fold against the front support panel 74a with the securing magnet 77 protruding through the hole 76 to allow the rear support panel 74b to fold flat against the front support panel 74a. This folded placement can prevent the support panel 74 from blocking the user's view of the instrument panel 18. When unfolding for use, the support panel 74 can be pivoted up around the front hinge 73a from its position in FIG. 5B while the rear support panel 74b is pivoted slightly away from front support panel 74a so that its lower edge can fit against one of the plurality of tabs 78. Then the portable device 19, or other portable device, can be magnetically secured to the front support panel 74a for use. The weight of the portable device 19 combined with the backward leaning geometry of the front support surface 74a provides the force needed to hold the support panel 74 and portable device 19 in place during use.

The portable device holder 80, once installed over a motor vehicle's steering column, dashboard and/or gap, can be operated similar to portable device holder 70, but with a simplified structure. The portable device 19 can be mounted to the support panel 84 using the securing magnet 87. The support panel 84 and portable device 19 can be pivoted around the hinge 83 between a stowed position shown in FIG. 5C and an operational position shown by the operational position 84z in shadow lines. In the operational position 84z, the “L” shape of the support panel 84 determines the angle of upper panel 84b during use and allows the range of motion 89. As illustrated, in its stowed position, the lower panel 84a provides substantially the same function as the vertical panel 75 seen in FIG. 5B, to provide space for folding the portable device 19 forward for stowage when attached to upper panel 84b. In some embodiments, the hinge 83 can comprise a friction hinge that can provide a constant friction against rotation for smooth positional adjustment of the support panel 84 by the user.

From the above portable device holder illustrations it should be apparent to the reader that many other variations exist for the support means which can hold a smartphone, a cellular phone, an electronic tablet or other electronic and non-electronic devices. The securing means examples of magnetic connectors 27, 27a-b, 77 and 87 (magnets), and spring-loaded gripping arms 34a-b, are but three examples for a means of securing a portable device (i.e., portable device 19) to a portable device holder. Similarly, from the above portable device holder illustrations it should be apparent to the reader that many other variations exist for holding the portable device holder in place against a motor vehicle's steering column, dashboard and/or gap between them. The examples of the compressible foam pads 28a-b, double-sided adhesive foam pad 28c, spring-loaded attachment arms 53 and 54a-b, hanging weight 61b and conformable weighted bags 67a, 71a and 81a are but a few examples of removable attachment means that can be used to hold the disclosed portable device holders in place during use.

In alternative embodiments, the foam pads 28a-c and 58 or the conformable weighted bags 67a, 71a and 81a can comprise an expandable foam polymer material that can be crushed and then slowly expands to fill the vertical and horizontal channels 17a-b. In this way, the expandable foam material can be compressed and then inserted into the gap between the motor vehicle's steering column and dashboard. The expandable foam material would then expand by itself to fill the gap and lock its respective portable device holder in place. Such expandable foam materials can be used in place of the removable attachment means 61, 67, 71 and 81. In some embodiments, the removable attachment means can comprise a flexible support core around which the expandable foam material can be bonded. In other embodiments, the expandable foam material can be coated with an air-tight layer and a valve installed to maintain a vacuum within the expandable foam material. In this way the air can be forced out of the valve and closed so that the removable attachment means can be inserted into the vertical and horizontal channels 17a-b (the gap). After insertion, the valve can be opened to allow air into the expandable foam material so that it can fill the vertical and horizontal channels 17a-b. In other embodiments, the disclosed removable attachment means can comprise an inflatable bladder(s) that can be inflated by the user to press against the walls of the vertical and horizontal channels 17a-b and secure the portable device holder in place. In some embodiments, the inflatable bladder can replace the conformable weighted bags 67a, 71a and 81a. In at least one embodiment, a pump and valve can be incorporated into the portable device holder to allow inflation and deflation of the inflatable bladder(s) respectively. These above mentioned embodiments and removable attachment means can be mounted in different locations than illustrated to allow for the different configurations, and spacing and positions of the interior mounting surface 14, steering column surface 14a, interior mounting surface 16 and dashboard surface 16a relative to one another. For example, the removable attachment means 81 might comprise an inflatable bladder that is positioned just under the front portion 82a for motor vehicles that cannot provide support for the removable attachment means with the steering column surface 14a because that surface is not available for one reason or another. In such a system, the inflatable bladder provides excellent attachment to the vertical and horizontal channels 17a-b, and the inflatable bladder's placement forward of the hinge 83 protects the portable device holder from forces trying to rotate it forward. Many other similar combinations of functionally similar components can be used to provide a functioning portable device holder that can secure itself in or around the gap between the steering column and dashboard.

Therefore, the disclosed systems and methods are well adapted to attain the ends and advantages mentioned as well as those that are inherent therein. The particular embodiments disclosed herein are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

1. A device holder, comprising:
a removable attachment means designed for secure and removable attachment within a gap formed by a steering column and a dashboard of a motor vehicle;
a support means adapted for temporary attachment of a portable device, whereby the portable device can be temporarily secured to the support means for use; and
a pivotal hinge connecting the removable attachment means to the support means, wherein the pivotal hinge defines a stowed position and an operational position for the support means with respect to the removable attachment means,
wherein the support means and portable device when in the stowed position provides a substantially unobstructed view of an instrument panel on the motor vehicle, and
wherein the support means and portable device in the operational position orients the portable device to face the user.

2. The device holder of claim 1, wherein the support means further includes one or more magnetic connectors for temporary attachment of the portable device.

3. The device holder of claim 1, further including a wireless charger.

4. The device holder of claim 1, wherein the removable attachment means comprises an attachment plate adapted to support one or more foam pads.

5. The device holder of claim 1, wherein the removable attachment means comprises a center attachment arm, a left and right attachment arms and at least one biasing spring tending to bias the center attachment arm away from the left and/or right attachment arms.

6. The device holder of claim 1, wherein the removable attachment means comprises an angled section, wherein the angled section is adapted to extend through a vertical channel between the steering column and the dashboard during use.

7. The device holder of claim 1, wherein the removable attachment means comprises an angled section, wherein the angled section is adapted to extend the pivotal hinge above an upper surface of the steering column during use.

8. The device holder of claim 7, wherein the removable attachment means defines an angle section with an angle of between ninety and one hundred sixty degrees.

9. The device holder of claim 1, wherein the removable attachment means comprises an angled section, wherein the angled section is adapted to extend the pivotal hinge above an upper surface of the steering column during use, wherein the removable attachment means defines an angle section with an angle of between ninety and one hundred sixty degrees.

10. The device holder of claim 1, wherein the support means comprises two retractable arms tending to retract toward each other and designed to grip opposite edges of a portable device and hold the portable device securely in place on the device holder during use.

11. The device holder of claim 10, wherein the two retractable arms are spring loaded.

12. A device holder, comprising:
a removable attachment means designed for removable attachment in a gap formed between a steering column and a lower dashboard of a motor vehicle, wherein the removable attachment means is adapted to rest on an upper surface of the steering column and/or lower dashboard;
a support means defining a support panel for temporary placement of a portable device on the support panel, whereby a smartphone, an electronic tablet or a marker board can rest against the support panel during use; and
a pivotal hinge connecting the removable attachment means to the support means, wherein the support means is pivotal to a stowed position and an operational position;
wherein the support means and portable device in the operational position are positioned substantially upright in front of an instrument panel on the motor vehicle, and wherein the support means and portable device in the stowed position are positioned to provide a user with an unobstructed view of the instrument panel.

13. The device holder of claim 12, wherein the removable attachment means comprises a weighted structure that engages the gap formed between the steering column and lower dashboard.

14. The device holder of claim 12, wherein the removable attachment means comprises a conformable bag designed to engage the gap formed between the steering column and lower dashboard.

15. The device holder of claim 12, wherein the support means comprises a front support panel and a rear support panel, wherein the front and rear support panels are connected by a second hinge, wherein the stowed position is defined by the front and rear support panels folded flat against one another.

16. The device holder of claim 15, wherein the pivotal hinge and/or the second hinge are living hinges.

17. The device holder of claim 12, wherein the removable attachment means comprises a base plate with a weighted structure designed to engage the gap, wherein the base plate is adapted to rest on the steering column and/or lower dashboard.

18. The device holder of claim 12, wherein the removable attachment means comprises a conformable weighted bag designed to engage the gap, wherein the conformable weighted bag covers more than half the underside of the removable attachment means.

19. The device holder of claim 12, wherein the removable attachment means comprises a conformable bag filled with a granular material.

20. The device holder of claim 12, wherein the support means comprises one or more magnetic connectors.
